(19) United States
(12) Patent Application Publication
(10) Pub. No.: US 2007/0189041 A1
(43) Pub. Date: Aug. 16, 2007

(54) BACKLIGHT MODULE AND ILLUMINANT STRUCTURE THEREOF

(75) Inventors: Sheng-Jie Chen, Taichung County (TW); Chih-Kang Wu, Hsinchu County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU OPTRONICS CORP., Hsinchu 300 (TW)

(21) Appl. No.: 11/427,399

(22) Filed: Jun. 29, 2006

(30) Foreign Application Priority Data
Feb. 13, 2006 (TW) 95104725

(51) Int. Cl. F21V 7/04

(52) U.S. Cl. 362/631

(57) ABSTRACT

An illuminant structure, adapted to a liquid crystal display, is provided. The illuminant structure includes a printed circuit board (PCB) having a conducting line and a connector. The connector is mounted on the back side of the PCB and electrically connected to the conducting line. A socket is mounted on the top side of PCB and electrically connected to the conducting line. A lamp having an external electrode is bracketed by and electrically connected to the socket.

### BACKGROUND OF THE INVENTION

1. Field of the Invention

The invention relates to an illuminant structure, and in particular to a backlight module for a liquid crystal display.

2. Description of the Related Art

A liquid crystal display is mainly constituted by a liquid crystal panel and a backlight module. A conventional liquid crystal panel comprises a top glass substrate and a bottom glass substrate on which a TFT (thin film transistor) matrix is formed with a liquid crystal layer filled therebetween. Each TFT controls the direction of liquid crystal molecules to achieve different light transmission rates provided by the backlight module. Referring to FIG. 1 and FIG. 2A, FIG. 1 is a diagram of conventional illuminant structure of liquid crystal display and FIG. 2A is a detailed diagram of area II of FIG. 1. The backlight module includes two spacers 102 respectively fixed on both sides of a frame 101. Only one side of frame 101 is given as an example for brevity. At least one set of stamping parts 103 is fixed on the spacer 102, wherein sockets 104 are mounted on stamping parts 103, or sockets 104 and stamping parts 103 are formed simultaneously from sheet metal. Lamps 108 with lamp external electrodes 109 are then installed in sockets 104 via a hole 105 in spacer 102. By screwing an electric wire 106 with a screw 107 on the stamping part 103, lamps 108, sockets 104, stamping parts 103 and the electric wire 106 electrically connect as a single path. FIG. 2B is a diagram of backside of FIG. 2A. The frame 101 has a predetermined opening 111 aligned with hole 105, which is on the spacer 102. The electric wire 106 passes through the hole 105 and predetermined opening 111 and electrically connects to the inverter 110, which is disposed on the backside of frame 101. According to this backlight module structure, the control signals, provided by the inverter 110 on the backside of frame 101, transfer from the electric wire 106 to the stamping part 103; thus, all of the lamps 108 fixed on the same stamping part 103 turn on or off at the same time.

However, the described method allows particles to easily enter the backlight module from hole 105 and predetermined opening 11, thus, gomi appears when displaying the images. Because the stamping parts 103 and the sockets 104 are produced by forming sheet-metal, controlling the manufacturing tolerance thereof is difficult, thus negatively influencing assembly of backlight modules. Due to the larger metal area of the stamping parts 103, parasitical capacitance is also increased.

### BRIEF SUMMARY OF THE INVENTION

To achieve higher PCB process precision, better fabrication and lower parasitical capacitance, the invention provides an illuminant structure, for a liquid crystal display, including a printed circuit board (PCB), a socket, and a lamp having external electrodes. The PCB has a conducting line and a connector, set on the back side of the printed circuit board and electrically connecting to the conducting line. The socket is mounted on the top side of the printed circuit board and electrically connects to the conducting line. And the lamp having external electrodes, bracketed by and electrically connecting to the sockets.

The invention further provides a backlight module, for a liquid crystal display, including a frame, an inverter arranged in the frame, a printed circuit board having a conducting line and a connector, a plurality of sockets, a plurality of lamps having external electrodes, and at least one optical film. The connector is on the back side of the printed circuit board and electrically connected to the conducting line and the inverter. The plurality of sockets are mounted on the top side of the printed circuit board and electrically connected to the conducting line. The plurality of lamps have external electrodes, bracketed by and electrically connected to the sockets, and at least one optical film set over the plurality of lamps in the frame.

### BRIEF DESCRIPTION OF THE DRAWINGS

The invention can be more fully understood by reading the subsequent detailed description and examples with references made to the accompanying drawings, wherein:

FIG. 1 is diagram of a conventional illuminant structure of a liquid crystal display;

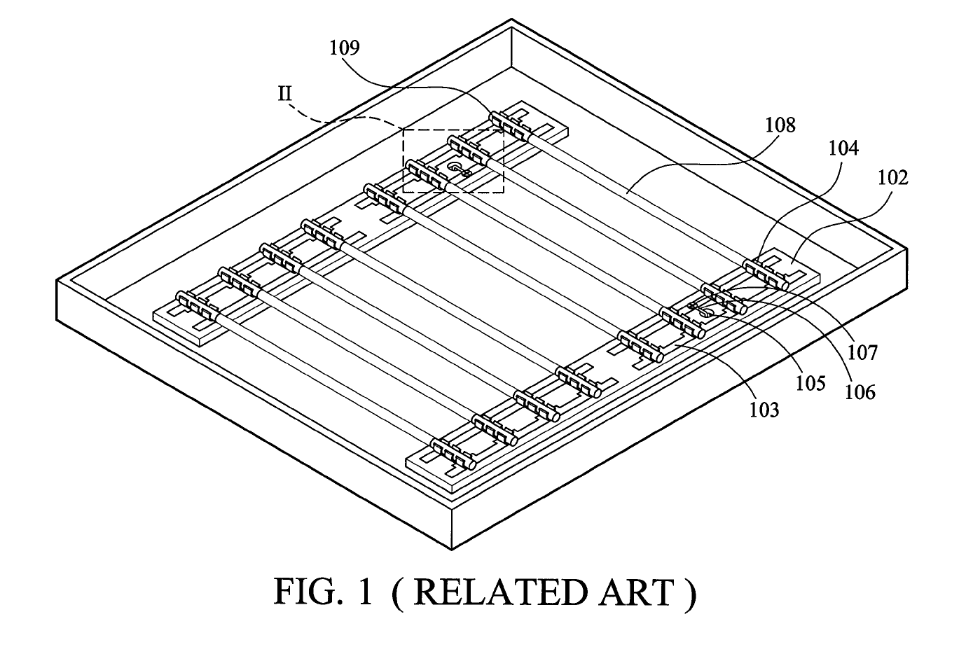

FIG. 2A is a detailed diagram of area II in FIG. 1;

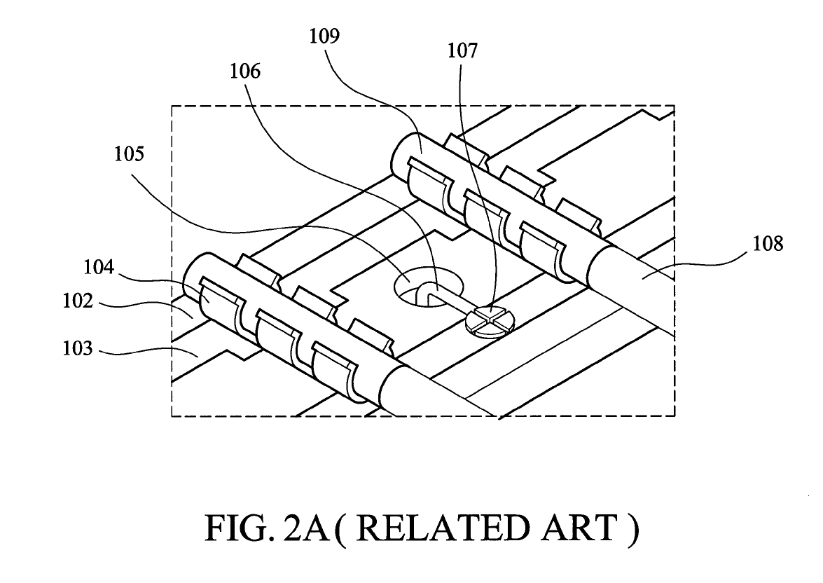

FIG. 2B is a diagram of backside of FIG. 2A;

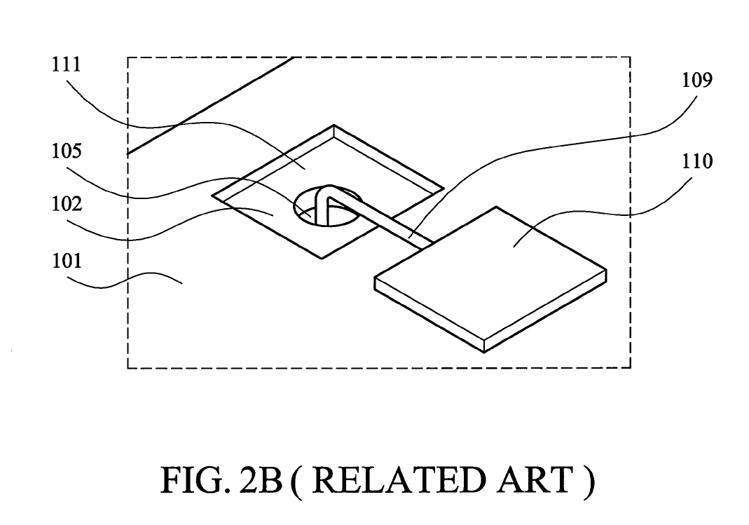

FIG. 3 is a diagram of a liquid crystal display backlight module according to the invention;

FIG. 4 is a diagram of a illuminant structure according to the invention;

FIG. 5A is a detailed diagram of area V in FIG. 4; and

FIG. 5B is a diagram of the backside of FIG. 5A.

### DETAILED DESCRIPTION OF THE INVENTION

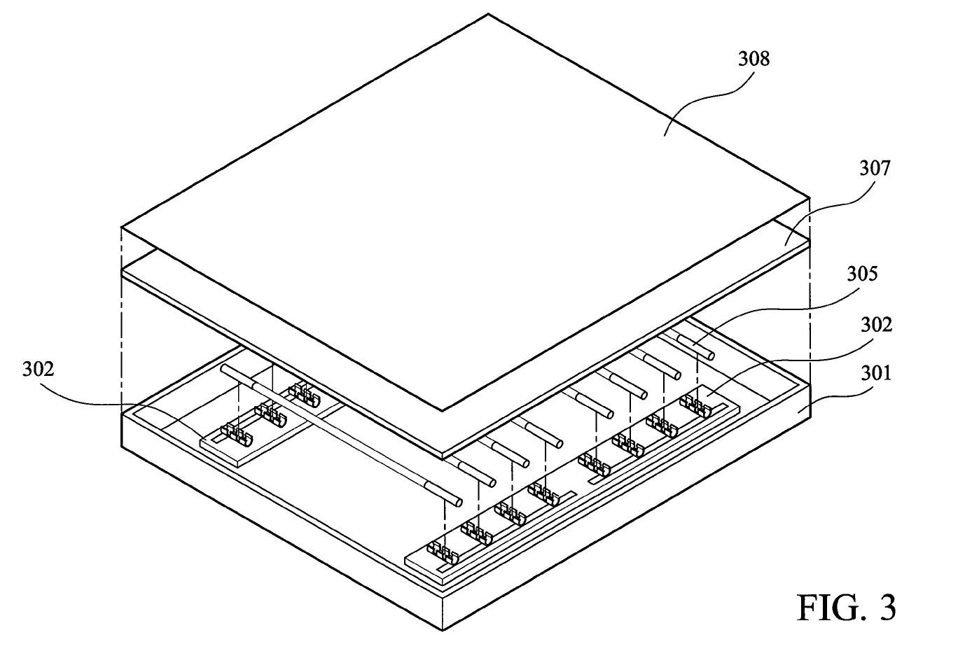

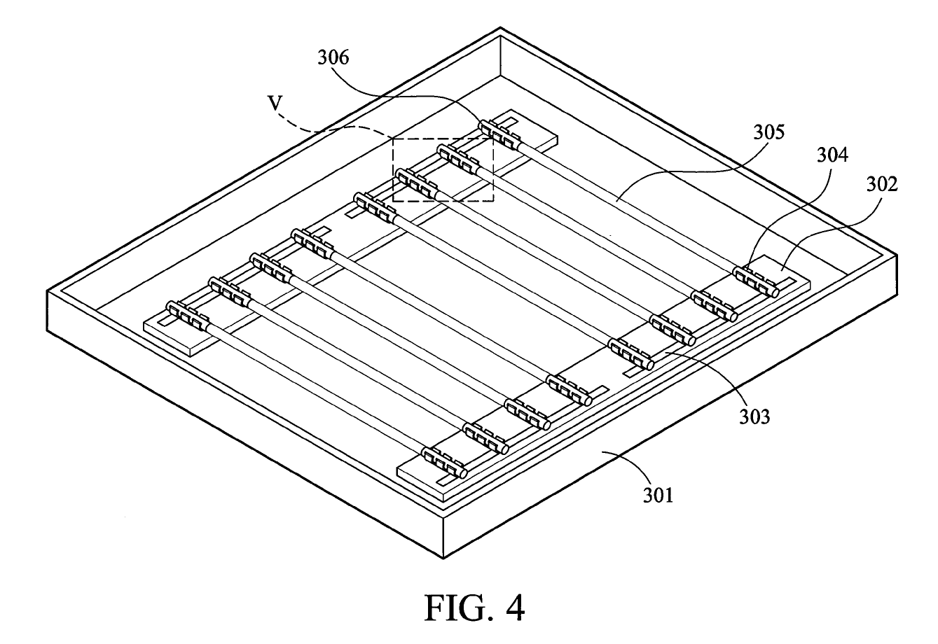

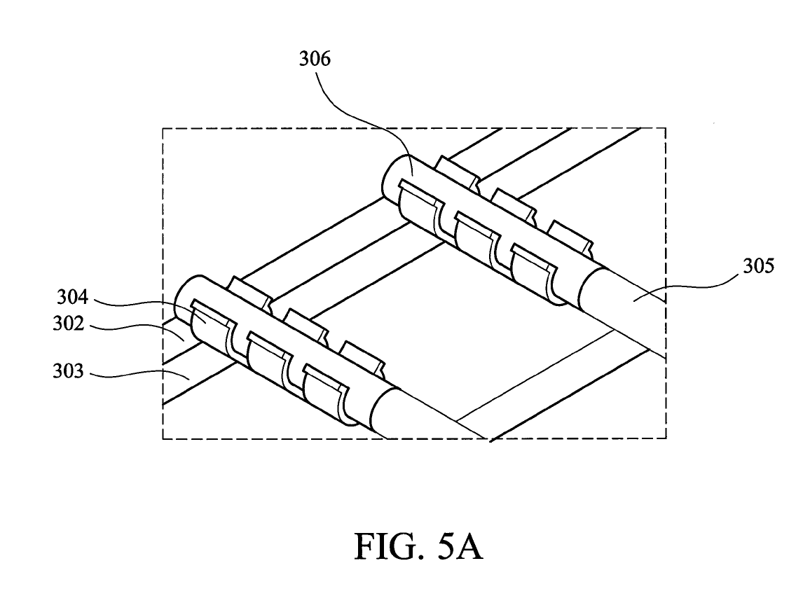

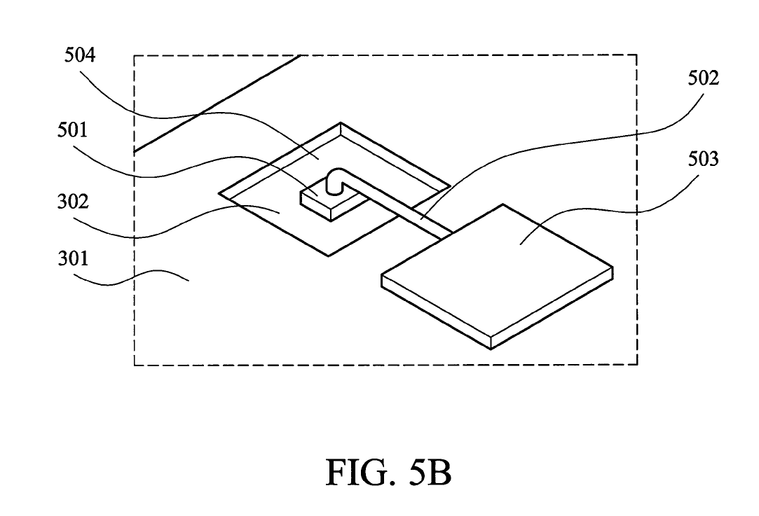

FIG. 3 is a diagram of a liquid crystal display backlight module according to the present invention. Both the right side and left side have a PCB 302 (printed circuit board) in the frame 301, lamps 305 disposed on the PCB 302, a diffuser 307 over the lamps 305, and a prism plate 308 above the diffuser 307. Refer to FIG. 4 and FIG. 5A at the same time for clear description; FIG. 4 is a diagram of the illuminant structure of the invention, and FIG. 5A is a detailed diagram of area V in FIG. 4. The illuminant structure includes two PCB 302 set on right side and left side respectively, which has conducting lines 303 and a plurality of sockets 304 arranged on the top side of PCB 302, wherein a plurality of sockets 304 electrically connect to the conducting lines 303 laying on the top side of PCB 302, and a plurality of lamps 305 with lamp external electrodes 306, which are fixed on the sockets 304. The illuminant structure is placed in a frame 301. The lamps 305 in the sockets 304, electrically connect to the same conducting line 303, are disposed parallel to the light source. FIG. 5B is a diagram of the backside of FIG. 5A. At least one connector 501 is aligned to the predetermined opening 504 on the frame 301, which electrically connects to the conducting line 303 shown in FIG. 5A. The connector 501 electrically connects to an inverter 503 by an electric wire 502. The inverter 503 provides the signals to each light source set; the signals are transferred by electric wire 502 and connector 501 to the conducting lines 303, the sockets 304, and the lamps 305, shown in FIG. 5A, for controlling on or off to each set of light source. Considering the difficulty and layout requirement, conducting lines 303 can be laid on the top side, back side, or both sides of the PCB 302. According to different products requirements, light guides and various optical films can be disposed over the light source to improve the quality of the light source, such as diffusers, brightness enhancement films and prism films (shown in FIG. 3).

By means of the PCB of invention, the inverter can electrically connect to the lamps through an electric wire and a connector without any opening, thus, the possibility of particles entering into the backlight module is reduced, higher PCB process precision is obtained and lower parasitical capacitance is achieved.

While the invention has been described by way of example and in terms of the preferred embodiment, it is to be understood that the invention is not limited to the disclosed embodiment. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An illuminant structure for use in a liquid crystal display, comprising:
a printed circuit board having a top side, a back side, a conducting line and a connector, wherein the connector is disposed on the back side of the printed circuit board and electrically connects to the conducting line;
a socket mounted on the top side of the printed circuit board and electrically connecting to the conducting line; and
a lamp having external electrodes held by and electrically connected to the sockets.

2. The illuminant structure as claimed in claim 1, further comprising an inverter electrically connecting to the connector.

3. The illuminant structure as claimed in claim 1, wherein the conducting line is disposed on the top side of the printed circuit board.

4. The illuminant structure as claimed in claim 1, wherein the conducting line is laid on the back side of the printed circuit board.

5. A backlight module, for a liquid crystal display, comprising:
a frame;
an inverter arranged in the frame;
a printed circuit board, in the frame, having a conducting line and a connector, wherein the connector is disposed on the back side of the printed circuit board and electrically connected to the conducting line and the inverter;
a plurality of sockets mounted on the top side of the printed circuit board and electrically connected to the conducting line;
a plurality of lamps, each of which has external electrodes, held by and electrically connected to the sockets; and
at least one optical film disposed over the plurality of lamps in the frame.

6. The backlight module as claimed in claim 5, wherein the at least one optical film comprises a diffuser, a prism film, or a brightness enhancement film.

7. The backlight module as claimed in claim 5, further comprising a light guide disposed over the plurality of lamps in the frame.

8. The backlight module as claimed in claim 5, wherein the conducting line is disposed on the top side of the printed circuit board.

9. The backlight module as claimed in claim 5, wherein the conducting line is disposed on the back side of the printed circuit board.
